(19) United States
(12) Patent Application Publication
(10) Pub. No.: US 2006/0204689 A1
(43) Pub. Date: Sep. 14, 2006

(54) Ink jet recording sheet

(76) Inventors: Hiroshi Tsukamoto, Chiba-shi (JP); Kazuo Totani, Tokyo (JP); Hiroshi Ito, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/367,654

(22) Filed: Mar. 3, 2006

(30) Foreign Application Priority Data
Mar. 9, 2005 (JP) 2005-066113

(51) Int. Cl. B41M 5/00

(52) U.S. Cl. 428/32.38

(57) ABSTRACT

The present invention relates to an ink jet recording sheet comprising: a support; and an ink-receiving layer containing a polycarbonate-based urethane resin and a polyether-based urethane resin formed on the support.

### BACKGROUND OF THE INVENTION

1. Field of the Invention

The present invention relates to an ink jet recording sheet which is applicable to an ink jet recording system using a solvent-based ink.

The present invention claims priority on Japanese Patent Application No. 2005-66113, filed on Mar. 9, 2005, the content of which is incorporated herein by reference.

2. Description of the Related Art

Because ink jet recording systems enable computer-printing and have various advantages such as low-noise, high-density recording performance, adaptability for full color, and the like, they have been rapidly spreading, and widely used for business advertisements as well as for household use.

Among these, since displays for business advertisements, particularly ones placed outdoors, are required to have light resistance and water resistance, a transparent film is conventionally coated on the surface on which a pigment-ink is used for ink jet recording. However, coating with a transparent film has a problem in that the number of steps required for making the displays increases.

In order to solve this problem, a solvent-based pigment-ink in which a pigment is dispersed in a solvent is used to obtain displays by forming images on an ink jet recording sheet by using an ink jet printer for solvent-based pigment-ink (hereinafter, referred to as a solvent-based pigment-ink jet printer).

In the meantime, as a conventional ink jet recording sheet, one in which an ink-receiving layer exhibiting an excellent ink-absorptivity for a water-based ink mainly used for ink jet recording is formed on a support has been widely used. However, since such an ink jet recording sheet exhibits a low absorptivity for an organic solvent, there is a problem in which images with high-definition and bright-coloration cannot be formed even when a solvent-based pigment-ink jet printer is used for printing.

Accordingly, as an ink jet recording sheet for a solvent-based pigment-ink jet printer, a polyvinyl chloride substrate having no ink-receiving layer has been conventionally used. However, since there are many people who consider it better to avoid the use of polyvinyl chloride in view of its undesirable effect on environment, an ink jet recording sheet suitable for a solvent-based pigment-ink and which does not contain polyvinyl chloride is required.

As the ink jet recording sheet suitable for a solvent-based pigment-ink and which does not contain polyvinyl chloride, a sheet in which an ink-receiving layer containing polyurethane is formed on a support has been proposed. For example, Patent Document 1 (Japanese Unexamined Patent Application, First Publication No. 2003-025723) discloses that an ink-receiving layer is formed by a resin composition containing polyurethane resin emulsion having a polycarbonate chain and/or polyester chain in its molecule.

However, although the invention disclosed in Patent Document 1 can increase the absorptivity for a solvent-based pigment-ink, cracks are often caused on the ink-receiving layer after being subjected to printing.

### SUMMARY OF THE INVENTION

An ink jet recording sheet according to the present invention includes a support and an ink-receiving layer containing a polycarbonate-based urethane resin and polyether-based urethane resin formed on the support.

In the ink jet recording sheet according to the present invention, it is preferable that a mass ratio of the polycarbonate-based urethane resin to the polyether-based urethane resin in the ink-receiving layer be within a range between 3 to 1 and 1 to 3.

Also, it is preferable that the polycarbonate-based urethane resin has a glass-transition temperature within a range from 60 to 100° C. and the polyether-based urethane resin has a glass-transition temperature within a range from 30 to 50° C.

Moreover, it is preferable that the ink-receiving layer further includes a pigment in an amount of 10 to 60 parts by mass with respect to 100 parts by mass of the total amount of the polycarbonate-based urethane resin and the polyether-based urethane resin.

### DETAILED DESCRIPTION OF THE INVENTION

An object of the present invention is to provide an ink jet recording sheet which is suitable for a solvent-based pigment-ink jet printer despite the fact that it contains no polyvinyl chloride, exhibits high absorption of a solvent-based pigment-ink and hardly generates cracks on its ink-receiving layer after being subjected to printing.

The ink jet recording sheet according to the present invention has a support and an ink-receiving layer containing a polycarbonate-based urethane resin and polyether-based urethane resin, the ink-receiving layer being formed on the support.

In the following, respective components of the ink jet recording sheet according to the present invention will be explained in detail.

(Support)

Although there are no particular limitations imposed on the support and any types of substrates applicable to an ink jet recording sheet can be used, waterproof supports such as resin films or sheets in which paper substrates are coated with resins are preferable due to their waterproof properties. Among the waterproof supports, the resin films are more preferable.

As the resin films, films of thermoplastic resins are used, and specific examples thereof include films of polyester, polyolefin, and the like. Examples of polyester include polyethylene terephthalate, polybutylene terephthalate, polycyclohexene terephthalate, and the like. Examples of polyolefin include polyethylene, polypropylene, ethylene-propylene copolymer, ethylene-vinyl acetate copolymer, and ones containing them as the main component thereof. At least one of the thermoplastic resins may be arbitrarily selected. Moreover, resins other than the above-mentioned thermoplastic resin, such as, for example, polystyrene (meth)acrylic ester copolymer, or the like, may be included in the films.

Moreover, it is preferable that the resin films be oriented films formed by being longitudinally and/or laterally drawn due to the high strength thereof.

Also, as the resin films, synthetic paper may be used. Synthetic paper refers to every kind of resin film manufactured into a paper-like form on which writing or printing can be performed.

Specific examples of the synthetic paper include a sheet in which fine pores are formed by kneading into a film a substance capable of easily dissolving a material of the film and dissolving out the material, a sheet in which fine pores are formed by using a foaming agent, a sheet formed by mixing an inorganic fine powder with the thermoplastic resin to form a film, followed by uniaxially or biaxially drawing the film to form fine pores inside the film, and the like. Also, as the synthetic paper, one in which the above-mentioned sheet is laminated on one side or both sides of the resin film may be used. Since these synthetic papers have a good texture and feel, they are preferably used when such characteristics are required.

The opacity of the resin film is not particularly limited, and may be arbitrarily decided.

Examples of the paper substrates to be coated with resins include high-quality paper, art paper, coated paper, cast-coated paper, craft paper, and the like. Also, as the resins used for coating the paper substrates, the same ones as the thermoplastic resins of the resin films may be used.

(Ink-Receiving Layer)

The polycarbonate-based urethane resin contained in the ink-receiving layer is a urethane resin having a carbonate chain, and the polyether-based urethane resin is a urethane resin having an ether chain and having neither an ester chain nor a carbonate chain.

In order to produce the urethane resin having a polycarbonate chain in its molecule, it is preferable that a polycarbonate polyol is used as a polyol.

Examples of the polycarbonate polyol include compounds obtained by reacting glycol such as 1,4-butanediol, 1,6-hexanediol, diethylene glycol, or the like, with diphenylcarbonate and phosgene. These may be used alone or in combination with two or more kinds thereof.

In order to produce the urethane resin having an ether chain in its molecule and having neither an ester chain nor a carbonate chain, it is preferable that a polyether polyol is used as a polyol.

Examples of the polyether polyol include addition polymers produced by reacting at least one kind of monomer such as ethylene oxide, propylene oxide, butylene oxide, styrene oxide, epichlorohydrin, tetrahydrofuran, cyclohexylene, or the like, with at least one kind of compound having at least two active hydrogen atoms such as ethylene glycol, diethylene glycol, triethylene glycol, propylene glycol, trimethylene glycol, 1,3-butanediol, 1,4-butanediol, 1,6-hexanediol, neopentyl glycol, glycerin, trimethylol ethane, trimethylol propane, sorbitol, cane sugar, aconitic acid, trimellitic acid, hemimellitic acid, phosphoric acid, ethylenediamine, diethylenetriamine, triisopropanolamine, pyrogallol, dihydroxybenzoic acid, hydroxyphthalic acid, 1,2,3-propane trithiol, or the like, the compounds being used as initiators.

Moreover, polyols other than the above-mentioned polycarbonate polyol and the polyether polyol may be contained in the ink-receiving layer as long as the physical properties thereof are not deteriorated. Examples of the polyols other than the polycarbonate polyol and the polyether polyol include polyester polyol, polyacetal polyol, polyacrylate polyol, polyester-polyether polyol, polyester amide polyol, polythioether polyol, and polyolefin polyols such as polybutadiene, and the like.

There are no particular limitations imposed on isocyanate which is reacted with the polyol to produce the urethane resin, and examples thereof include 2,4-tolylenediisocyanate, 2,6-tolylenediisocyanate, m-phenylenediisocyanate, 4,4′-diphenylmethanediisocyanate, p-phenylenediisocyanate, 2,4′-diphenylmethanediisocyanate, 2,2′-diphenylmethanediisocyanate, 3,3′-dimethyl-4,4′-biphenylenediisocyanate, 1,5-naphthalenediisocyanate, 1,5-tetrahydronaphthalenediisocyanate, tetramethylendiisocyanate, 1,6-hexamethylendiisocyanate, dodecamethylendiisocyanate, trimethylhexamethylendiisocyanate, 1,3-cyclohexylenediisocyanate, 1,4-cyclohexylenediisocyanate, xylylenediisocyanate, tetramethylene xylylenediisocyanate, lysinediisocyanate, isophoronediisocyanate, 4,4′-dicyclohexylmethanediisocyanate, 3,3′-dimethyl-4,4′-dicyclohexylmethanediisocyanate, and the like. These may be used alone or in combination with two or more kinds thereof. Among these, aliphatic isocyanates and/or cycloaliphatic isocyanates are preferable.

It is preferable that the total amount of the polycarbonate-based urethane resin and the polyether-based urethane resin in the ink-receiving layer be 50% by mass or more. When the total amount of the polycarbonate-based urethane resin and the polyether-based urethane resin in the ink-receiving layer is 50% by mass or more, it is possible to further increase the absorption of the solvent-based pigment-ink and reliably prevent cracks from being generated after printing on the ink-receiving layer.

It is preferable that the polycarbonate-based urethane resin has a glass-transition temperature of 60 to 100° C., and the polyether-based urethane resin has a glass-transition temperature of 30 to 50° C. When the glass-transition temperatures of the polycarbonate-based urethane resin and the polyether-based urethane resin are no more than the respective upper limits, the rate of absorption of the solvent-based pigment-ink further increases, and so the drying rate further increases. On the other hands, when the glass-transition temperatures of the polycarbonate-based urethane resin and the polyether-based urethane resin are no less than the respective lower limits, it is possible to prevent ink jet recording sheets put in layers from adhering to each other (blocking).

The polycarbonate-based urethane resin having a glass-transition temperature of 60 to 100° C. and the polyether-based urethane resin having a glass-transition temperature of 30 to 50° C. are easily available commercially.

In the ink-receiving layer, it is preferable that the mass ratio of the polycarbonate-based urethane resin to the polyether-based urethane resin (polycarbonate-based urethane resin/polyether-based urethane resin) be within a range between 3/1 and 1/3 in order to improve the printing quality. When the mass ratio of the polycarbonate-based urethane resin to the polyether-based urethane resin (polycarbonate-based urethane resin/polyether-based urethane resin) is over 3/1, crack-like defects may be caused on the print side. On the other hand, when the mass ratio of the polycarbonate-based urethane resin to the polyether-based urethane resin (polycarbonate-based urethane resin/polyether-based urethane resin) is below 1/3, the rate of absorption of the solvent-based pigment-ink tends to be slow, and so the drying rate tends to be slow.

In the ink-receiving layer, a pigment may be further contained. By containing the pigment, it is possible to prevent the ink jet recording sheets put in layers from adhering to each other (blocking).

Examples of the pigment include silica, alumina, pseudoboehmite, calcium carbonate, kaolin, nylon filler, and the like.

The content of the pigment in the ink-receiving layer is preferably 10 to 60 parts by mass with respect to 100 parts by mass of the total amount of the polycarbonate-based urethane resin and the polyether-based urethane resin.

Although the ink-absorptivity for the pigment is lower than that of the urethane resin, deterioration of printing quality can be prevented when the content of the pigment is no more than 60 parts by mass with respect to 100 parts by mass of the total amount of the polycarbonate-based urethane resin and the polyether-based urethane resin. On the other hand, when the content of the pigment is no less than 10 parts by mass with respect to 100 parts by mass of the total amount of the polycarbonate-based urethane resin and the polyether-based urethane resin, blocking of the ink jet recording sheets put in layers can be prevented.

The thickness of the ink-receiving layer is preferably 1 to 100 μm. When the thickness of the ink-receiving layer is less than 1 μm, the ink-absorptivity may not be sufficiently exhibited. On the other hand, when the thickness of the ink-receiving layer is over 100 μm, high cost tends to be incurred, which may not be practical.

The ink-receiving layer can be formed by applying onto a support a coating solution for forming the ink-receiving layer, followed by drying the coating solution, for example. As the coating solution for forming the ink-receiving layer, a paint in which the above-mentioned urethane resin is dissolved in a solvent, a water dispersion emulsion paint in which the above-mentioned urethane resin is dispersed in water, or the like may be used. Among them, the water dispersion emulsion paint is preferably used, because it can be easily handled.

Although the particle diameter of an emulsion particle contained in the water dispersion emulsion paint is not particularly limited, the particle diameter is preferably no more than 1 μm so as to improve the transparency of the ink-receiving layer as well as the printing quality thereof.

The coating solution for forming the ink-receiving layer may be applied by using various known application devices, such as a size press coater with two rolls or a metering blade, a gate roll coater, a bar coater, an air knife coater, a curtain coater, a rod blade coater, a blade coater, a lip coater, a die coater, or the like.

Since the ink jet recording sheet as described above has the ink-receiving layer containing the urethane resin, the ink jet recording sheet is suitable for the solvent-based pigment-ink jet printer in spite of not containing polyvinyl chloride. Moreover, since the ink-receiving layer contains the polycarbonate-based urethane resin, the ink-receiving layer can rapidly absorb a solvent-based ink such as a solvent-based pigment-ink, and so can be rapidly dried. Moreover, since the ink-receiving layer contains the polyether-based urethane resin, cracks are hardly generated in the ink-receiving layer after printing.

### EXAMPLES

In the following, the present invention will be explained in more detail with reference to Examples and Comparative Examples. However, it should be apparent that the present invention is not limited to these examples. Also, “parts” and “%” used in the respective examples indicate “parts by mass” and “% by mass” unless otherwise so indicated.

### Example 1

A polyester film having a thickness of 50 μm was used as a support, on one side of which a coating solution for forming an ink-receiving layer A was applied and dried to obtain an ink jet recording sheet including the ink-receiving layer having a thickness of 20 μm after being dried.

Coating Solution for Forming Ink-receiving Layer A

| | |
|---|---|
| Polyether-based urethane resin (manufactured by DAI-ICHI | 50 parts |
| KOGYO SEIYAKU CO., LTD., under the trademark of | |
| SUPERFLEX 110, having a glass-transition temperature of | |
| 48° C.) | |
| Polycarbonate-based urethane resin (manufactured by Mitsui | 50 parts |
| Takeda Chemicals, Inc., under the trademark of TAKELAC | |
| W-635, having a glass-transition temperature of 70° C.) | |
| Amorphous silica (manufactured by Mizusawa Industrial | 30 parts |
| Chemicals, LTD., under the trademark of MIZUKASIL | |
| P-78F) | |
| Water (added so that the solid content in the coating solution | |
| is 20%) | |

### Example 2

An ink jet recording sheet was prepared in the same manner as described in Example 1 except that a coating solution for forming an ink-receiving layer B described below was used instead of the coating solution for forming the ink-receiving layer A.

Coating Solution for Forming Ink-receiving Layer B

| | |
|---|---|
| Polyether-based urethane resin (manufactured by DAI-ICHI | 20 parts |
| KOGYO SEIYAKU CO., LTD., under the trademark of | |
| SUPERFLEX 110) | |
| Polycarbonate-based urethane resin (manufactured by Mitsui | 80 parts |
| Takeda Chemicals, Inc., under the trademark of TAKELAC | |
| W-635) | |
| Amorphous silica (manufactured by Mizusawa Industrial | 30 parts |
| Chemicals, LTD., under the trademark of MIZUKASIL | |
| P-78F) | |
| Water (added so that the solid content in the coating solution | |
| is 20%) | |

### Example 3

An ink jet recording sheet was prepared in the same manner as described in Example 1 except that a coating solution for forming an ink-receiving layer C described below was used instead of the coating solution for forming the ink-receiving layer A.

Coating Solution for Forming Ink-receiving Layer C

| | |
|---|---|
| Polyether-based urethane resin (manufactured by DAI-ICHI | 80 parts |
| KOGYO SEIYAKU CO., LTD., under the trademark of | |
| SUPERFLEX 110) | |
| Polycarbonate-based urethane resin (manufactured by Mitsui | 20 parts |
| Takeda Chemicals, Inc., under the trademark of TAKELAC | |
| W-635) | |
| Amorphous silica (manufactured by Mizusawa Industrial | 30 parts |
| Chemicals, LTD., under the trademark of MIZUKASIL | |
| P-78F) | |
| Water (added so that the solid content in the coating solution | |
| is 20%) | |

### Example 4

An ink jet recording sheet was prepared in the same manner as described in Example 1 except that a coating solution for forming an ink-receiving layer D described below was used instead of the coating solution for forming the ink-receiving layer A.

Coating Solution for Forming Ink-receiving Layer D

| | |
|---|---|
| Polyether-based urethane resin (manufactured by DAI-ICHI | 50 parts |
| KOGYO SEIYAKU CO., LTD., under the trademark of | |
| SUPERFLEX 126, having a glass-transition temperature | |
| of 72° C.) | |
| Polycarbonate-based urethane resin (manufactured by Mitsui | 50 parts |
| Takeda Chemicals, Inc., under the trademark of TAKELAC | |
| W-635) | |
| Amorphous silica (manufactured by Mizusawa Industrial | 30 parts |
| Chemicals, LTD., under the trademark of MIZUKASIL | |
| P-78F) | |
| Water (added so that the solid content in the coating solution | |
| is 20%) | |

### Example 5

An ink jet recording sheet was prepared in the same manner as described in Example 1 except that a coating solution for forming an ink-receiving layer E described below was used instead of the coating solution for forming the ink-receiving layer A.

Coating Solution for Forming Ink-receiving Layer E

| | |
|---|---|
| Polyether-based urethane resin (manufactured by DAI-ICHI | 50 parts |
| KOGYO SEIYAKU CO., LTD., under the trademark of | |
| SUPERFLEX 110) | |
| Polycarbonate-based urethane resin (manufactured by DAI-ICHI | 50 parts |
| KOGYO SEIYAKU CO., LTD., under the trademark of | |
| SUPERFLEX 420NS, having a glass-transition temperature | |
| of −10° C.) | |
| Amorphous silica (manufactured by Mizusawa Industrial | 30 parts |
| Chemicals, LTD., under the trademark of MIZUKASIL P-78F) | |
| Water (added so that the solid content in the coating solution | |
| is 20%) | |

### Example 6

An ink jet recording sheet was prepared in the same manner as described in Example 1 except that a coating solution for forming an ink-receiving layer F described below was used instead of the coating solution for forming the ink-receiving layer A.

Coating Solution for Forming Ink-receiving Layer F

| | |
|---|---|
| Polyether-based urethane resin (manufactured by DAI-ICHI | 50 parts |
| KOGYO SEIYAKU CO., LTD., under the trademark of | |
| SUPERFLEX 110) | |
| Polycarbonate-based urethane resin (manufactured by Mitsui | 50 parts |
| Takeda Chemicals, Inc., under the trademark of TAKELAC | |
| W-635) | |
| Amorphous silica (manufactured by Mizusawa Industrial | 80 parts |
| Chemicals, LTD., under the trademark of MIZUKASIL | |
| P-78F) | |
| Water (added so that the solid content in the coating solution | |
| is 20%) | |

### Example 7

An ink jet recording sheet was prepared in the same manner as described in Example 1 except that a coating solution for forming an ink-receiving layer G described below was used instead of the coating solution for forming the ink-receiving layer A.

Coating Solution for Forming Ink-receiving Layer G

| | |
|---|---|
| Polyether-based urethane resin (manufactured by DAI-ICHI | 50 parts |
| KOGYO SEIYAKU CO., LTD., under the trademark of | |
| SUPERFLEX 110) | |
| Polycarbonate-based urethane resin (manufactured by Mitsui | 50 parts |
| Takeda Chemicals, Inc., under the trademark of TAKELAC | |
| W-635) | |
| Water (added so that the solid content in the coating solution | |
| is 20%) | |

### Comparative Example 1

An ink jet recording sheet was prepared in the same manner as described in Example 1 except that a coating solution for forming an ink-receiving layer H described below was used instead of the coating solution for forming the ink-receiving layer A.

Coating Solution for Forming Ink-receiving Layer H

| | | |
|---|---|---|
| Polyether-based urethane resin (manufactured by DAI-ICHI | 100 | parts |
| KOGYO SEIYAKU CO., LTD., under the trademark of | | |
| SUPERFLEX 110) | | |
| Amorphous silica (manufactured by Mizusawa Industrial | 30 | parts |
| Chemicals, LTD., under the trademark of MIZUKASIL | | |
| P-78F) | | |
| Water (added so that the solid content in the coating | | |
| solution is 20%) | | |

### Comparative Example 2

An ink jet recording sheet was prepared in the same manner as described in Example 1 except that a coating solution for forming an ink-receiving layer I described below was used instead of the coating solution for forming the ink-receiving layer A.

Coating Solution for Forming Ink-receiving Layer I

| | | |
|---|---|---|
| Polycarbonate-based urethane resin (manufactured by | 100 | parts |
| Mitsui Takeda Chemicals, Inc., under the trademark of | | |
| TAKELAC W-635) | | |
| Amorphous silica (manufactured by Mizusawa Industrial | 30 | parts |
| Chemicals, LTD., under the trademark of MIZUKASIL | | |
| P-78F) | | |
| Water (added so that the solid content in the coating | | |
| solution is 20%) | | |

### Comparative Example 3

An ink jet recording sheet was prepared in the same manner as described in Example 1 except that a coating solution for forming an ink-receiving layer J described below was used instead of the coating solution for forming the ink-receiving layer A.

Coating Solution for Forming Ink-receiving Layer J

| | | |
|---|---|---|
| Polyester-based urethane resin (manufactured by DAI-ICHI | 100 | parts |
| KOGYO SEIYAKU CO., LTD., under the trademark of | | |
| SUPERFLEX 620, having a glass-transition temperature | | |
| of 43° C.) | | |
| Amorphous silica (manufactured by Mizusawa Industrial | 30 | parts |
| Chemicals, LTD., under the trademark of MIZUKASIL | | |
| P-78F) | | |
| Water (added so that the solid content in the coating | | |
| solution is 20%) | | |

### Comparative Example 4

An ink jet recording sheet was prepared in the same manner as described in Example 1 except that a coating solution for forming an ink-receiving layer K described below was used instead of the coating solution for forming the ink-receiving layer A.

Coating Solution for Forming Ink-receiving Layer K

| | |
|---|---|
| Polyester-based urethane resin | 50 parts |
| (manufactured by DAI-ICHI KOGYO SEIYAKU CO., LTD., | |
| under the trademark of SUPERFLEX 620, | |
| having a glass-transition temperature of 43° C.) | |
| Polycarbonate-based urethane resin (manufactured by | 50 parts |
| Mitsui Takeda Chemicals, Inc., under the trademark | |
| of TAKELAC W-635) | |
| Amorphous silica (manufactured by Mizusawa Industrial | 30 parts |
| Chemicals, LTD., under the trademark of MIZUKASIL P-78F) | |
| Water (added so that the solid content in | |
| the coating solution is 20%) | |

### Comparative Example 5

An ink jet recording sheet was prepared in the same manner as described in Example 1 except that a coating solution for forming an ink-receiving layer L described below was used instead of the coating solution for forming the ink-receiving layer A.

Coating Solution for Forming Ink-receiving Layer L

| | |
|---|---|
| Acrylic resin (manufactured by NIPPON CARBIDE | 100 parts |
| INDUSTRIES CO., Inc., under the trademark of NIKASOL | |
| RX-969B, having a glass-transition temperature of 54° C.) | |
| Amorphous silica (manufactured by Mizusawa Industrial | 30 parts |
| Chemicals, LTD., under the trademark | |
| of MIZUKASIL P-78F) | |
| Water (added so that the solid content in the | |
| coating solution is 20%) | |

The ink jet recording sheets prepared in Examples 1 to 7 and Comparative Examples 1 to 5 were evaluated as described below after printing images at ISO-400 (“High-fine color digital standard image data ISO/JIS-SCID” page 13, Image name: Portrait, issued by Japanese Standards Association) by using a solvent ink jet printer (manufactured by Roland DG Corporation under the trade name of SJ540EX). Results are shown in Table 1.

(Drying Rate)

After printing images at ISO-400, the respective ink jet recording sheet was left at 22° C. for 5 minutes, and was then superposed on a copy paper to evaluate it visually with respect to transition of printing. When the drying rate is rapid, the amount of transition is little.

Criteria for evaluation with respect to transition

A: No transition was recognized.
B: Transition was scarcely recognized and there was no problem.
C: Transition was recognized and there was a possibility of a problem.
D: Transition was significantly recognized and there was a definite problem.
   (Cracks on Print Side)

After printing images at ISO-400, the respective ink jet recording sheet was left at 22° C. for 5 hours, and the print side thereof was observed visually to check the generation of cracks.

Criteria for evaluation with respect to cracks

A: No cracks were recognized.
B: Cracks were scarcely recognized and there was no problem.
C: Cracks were recognized and there was a possibility of a problem.
D: Cracks were significantly recognized and there was a definite problem.
   (Blocking)

Two sheets of the respective ink jet recording sheet were superposed without being printed, and the superposed sheets were pressed at 98 kPa and left at 40° C. for 12 hours. After that, the superposed sheets were evaluated visually with respect to the state of blocking.

Criteria for evaluation with respect to blocking

A: No blocking was recognized.
B: Blocking was scarcely recognized and there was no problem.
C: Blocking was recognized and there was a possibility of a problem.

D: Blocking was significantly recognized and there was a definite problem.

TABLE 1

| | Drying Rate | Cracks | Blocking |
|---|---|---|---|
| Example 1 | A | A | A |
| Example 2 | A | B | A |
| Example 3 | B | A | A |
| Example 4 | B | A | A |
| Example 5 | A | A | B |
| Example 6 | B | A | A |
| Example 7 | A | A | B |
| Comparative | C | A | B |
| Example 1 | | | |
| Comparative | A | D | A |
| Example 2 | | | |
| Comparative | C | A | D |
| Example 3 | | | |
| Comparative | B | A | C |
| Example 4 | | | |
| Comparative | D | A | B |
| Example 5 | | | |

The ink jet recording sheets of Examples 1 to 7 having the ink-receiving layer containing the polycarbonate-based urethane resin and the polyether-based urethane resin exhibited a rapid drying rate for the solvent-based ink, and were prevented from cracking on the print side thereof. Moreover, the ink jet recording sheets of Examples 1 to 7 in which the glass-transition temperature of the polycarbonate-based urethane resin was within a range from 60 to 100° C. and the glass-transition temperature of the polyether-based urethane resin was within a range from 30 to 50° C. were prevented from blocking.

On the other hand, the ink jet recording sheet of Comparative Example 1 of which the ink-receiving layer did not contain the polycarbonate-based urethane resin exhibited a slow drying rate for the ink.

The ink jet recording sheet of Comparative Example 2 of which the ink-receiving layer did not contain the polyether-based urethane resin cracked on the print side thereof.

The ink jet recording sheet of Comparative Example 3 of which the ink-receiving layer did not contain the polycarbonate-based urethane resin and the polyether-based urethane resin but contained the polyester-based urethane resin instead thereof exhibited a slow drying rate for the ink and also caused blocking.

In the ink jet recording sheet of Comparative Example 4 of which the ink-receiving layer did not contain the polyether-based urethane resin but contained the polyester-based urethane resin instead thereof, blocking was caused.

The ink jet recording sheet of Comparative Example 5 of which the ink-receiving layer did not contain the polycarbonate-based urethane resin and the polyether-based urethane resin but contained the acrylic resin instead thereof exhibited a slow drying rate for the ink.

As described above, the ink jet recording sheet according to the present invention is suitable for a solvent-based pigment-ink jet printer in spite of not containing polyvinyl chloride. Moreover, the ink jet recording sheet according to the present invention has excellent absorptivity for a solvent-based pigment-ink and the ink-receiving layer thereof scarcely cracked after printing.

What is claimed is:

1. An ink jet recording sheet comprising:
a support; and
an ink-receiving layer containing a polycarbonate-based urethane resin and a polyether-based urethane resin formed on the support.

2. An ink jet recording sheet according to claim 1, wherein a mass ratio of the polycarbonate-based urethane resin to the polyether-based urethane resin in the ink-receiving layer is within a range between 3/1 and 1/3.

3. An ink jet recording sheet according to claim 1, wherein the polycarbonate-based urethane resin has a glass-transition temperature within a range from 60 to 100° C. and the polyether-based urethane resin has a glass-transition temperature within a range from 30 to 50° C.

4. An ink jet recording sheet according to claim 1, wherein the ink-receiving layer further comprises a pigment in an amount of 10 to 60 parts by mass with respect to 100 parts by mass of the total amount of the polycarbonate-based urethane resin and the polyether-based urethane resin.
